(19) United States
(12) Patent Application Publication
(10) Pub. No.: US 2024/0405274 A1
(43) Pub. Date: Dec. 5, 2024

(54) RECHARGEABLE BATTERY

(71) Applicant: SAMSUNG SDI CO., LTD., Yongin-si (KR)

(72) Inventors: Seungryong OH, Yongin-si (KR); Myunghoon KIM, Yongin-si (KR); Aeran KIM, Yongin-si (KR); Yunhee KIM, Yongin-si (KR); Injun PARK, Yongin-si (KR); Jeongmin SHIN, Yongin-si (KR)

(21) Appl. No.: 18/488,872

(22) Filed: Oct. 17, 2023

(30) Foreign Application Priority Data
Jun. 5, 2023 (KR) 10-2023-0072449

(51) Int. Cl. H01M 10/0567; H01M 4/36; H01M 4/38; H01M 4/583; H01M 10/0569

(52) U.S. Cl. CPC H01M 10/0567; H01M 4/364; H01M 4/386; H01M 4/583; H01M 10/0569; H01M 2004/027; H01M 10/052

(57) ABSTRACT

A rechargeable lithium battery including a positive electrode, a negative electrode, and an electrolyte is provided. The electrolyte includes a non-aqueous organic solvent, a lithium salt, a first additive, and a second additive. The negative electrode includes a negative electrode active material including a Si—C composite mixed with a separate carbon-based compound.

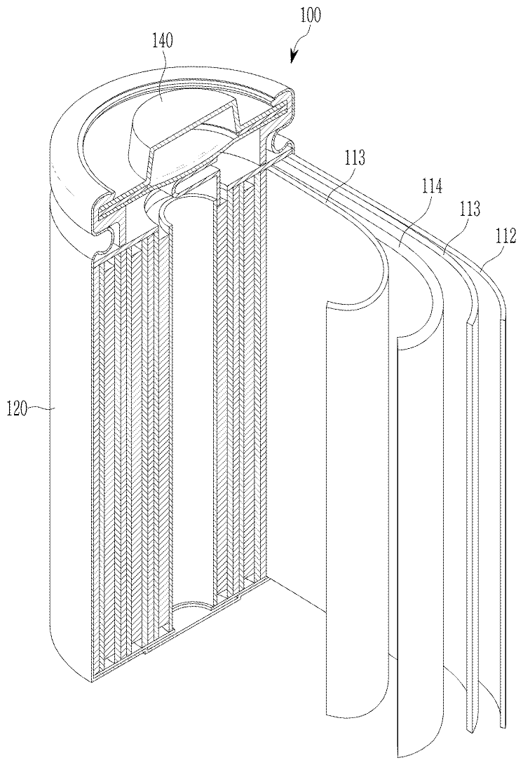

### CROSS-REFERENCE TO RELATED APPLICATION

This application claims priority to and the benefit of Korean Patent Application No. 10-2023-0072449, filed on Jun. 5, 2023, in the Korean Intellectual Property Office, the entire content of which is incorporated herein by reference.

### BACKGROUND

### 1. Field

One or more embodiments of the present disclosure relate to a rechargeable lithium battery.

### 2. Description of the Related Art

A rechargeable lithium battery may be recharged and has three or more times higher energy density per unit weight than a comparable lead storage (lead-acid) battery, a comparable nickel-cadmium battery, a comparable nickel-hydrogen battery, a comparable nickel-zinc battery and/or the like. The rechargeable lithium battery may be highly charged (e.g., to a relatively high energy density) and thus, is commercially manufactured for a laptop, a cell phone, an electric tool, an electric bike, and/or the like. Researches on improvement of the rechargeable lithium battery (e.g., to provide additional energy density) have been actively made.

The rechargeable lithium battery is manufactured by injecting an electrolyte into a (its) battery cell, which includes a positive electrode including a positive electrode active material capable of intercalating/deintercalating lithium and a negative electrode including a negative electrode active material capable of intercalating/deintercalating lithium.

One of the recent development directions for a rechargeable lithium battery is to increase energy density, which may impact the range of safe operating conditions for the battery. In this regard, a method of applying a Si—C composite or a mixture thereof with a carbon-based compound as a negative electrode active material has been studied.

However, as a content (e.g., amount) of the Si-based active material in a total negative electrode active material increases, there arise complications in that a loss of electrolyte may rapidly increase, a resistance of the rechargeable lithium battery may increase at room temperature and/or high temperature, and a cycle-life may decrease.

Accordingly, it is required to implement (or there is a desire for the implementation of) an electrolyte with an improved safety profile that avoids deteriorating performance at room temperature and/or high temperature.

### SUMMARY

Aspects of embodiments are directed toward a rechargeable lithium battery that has relatively high energy density, suppresses an increase in resistance of the rechargeable lithium battery at room temperature and/or high temperature, and ensures cycle-life characteristics. Additional aspects will be set forth in part in the description which follows and, in part, will be apparent from the description, or may be learned by practice of the presented embodiments of the disclosure.

Some example embodiments provide a rechargeable lithium battery including a positive electrode, a negative electrode, and an electrolyte, wherein the electrolyte includes a non-aqueous organic solvent, a lithium salt, a first additive, and a second additive, and the negative electrode includes a negative electrode active material including a Si—C composite mixed with a separate carbon-based compound.

The rechargeable lithium battery according to some example embodiments exhibits high energy density by applying the negative electrode active material including a Si—C composite mixed with a separate carbon-based compound. The rechargeable lithium battery according to some example embodiments prevents or protects from an increase in resistance at room temperature and/or high temperature and secures cycle-life characteristics by applying the electrolyte including two types (kinds) of additives.

### BRIEF DESCRIPTION OF THE DRAWING

The drawing is a schematic view showing a rechargeable lithium battery according to some example embodiments of the disclosure.

### DETAILED DESCRIPTION

Hereinafter, a rechargeable lithium battery according to some example embodiments of the present disclosure will be described in more detail with reference to the attached drawing, wherein like reference numerals refer to like elements throughout, and duplicative descriptions thereof may not be provided. In this regard, the present embodiments may be modified to have different forms and should not be construed as being limited to the descriptions set forth herein. Rather, the present disclosure is intended to cover all modifications, equivalents, and alternatives falling within the spirit and scope of the present disclosure. Accordingly, the embodiments are merely described by referring to the drawing, to explain aspects of the present description. However, these embodiments are only examples, and the present disclosure is not limited thereto, but rather the present disclosure is defined by the scope of claims.

As utilized herein, the term “and/or” includes any and all combinations of one or more of the associated listed items. Expressions such as “at least one of,” if (e.g., when) preceding a list of elements, modify the entire list of elements and do not modify the individual elements of the list.

If (e.g., when) it is described that an element is “on,” “connected to,” or “coupled to” another element, it will be understood that the element may be provided directly on another element or still another element may be interposed therebetween. On the other hand, if (e.g., when) it is described that an element is “directly on” another element, still another element is not interposed therebetween.

It will be understood that, although the terms “first,” “second,” and “third” may be utilized herein to describe one or more suitable elements, components, regions, layers, and/or sections, these elements, components, regions, layers, and/or sections should not be limited by these terms. These terms are only utilized to distinguish one element, component, region, layer, or section from another region, layer, or section. Thus, a first element, component, region, layer, or section described herein may be termed a second element, component, region, layer, or section without departing from the teachings of the present specification.

As utilized herein, the singular forms “a,” “an,” and “the” are intended to include the plural forms, including “at least one,” unless the content (e.g., amount) clearly indicates otherwise. As used herein, expressions such as “at least one,” “one of,” and “selected from,” if (e.g., when) preceding a list of elements, should not be construed as being limited to the singular, but may modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As utilized herein, the term “and/or” includes any and all combinations of one or more of the associated listed items. The terms “include,” “includes,” “including,” “comprise,” “comprises,” “comprising,” “having,” “has,” and/or “have” if (e.g., when) utilized in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be utilized herein to easily describe one element or feature's relationship to another element or feature. It will be understood that the spatially relative terms are intended to encompass different orientations of a device in utilization or operation in addition to the orientation illustrated in the drawing. For example, if (e.g., when) a device in the drawings is turned over, elements described as “below” or “beneath” other elements or features would then be “above” or “over” the other elements or features. Thus, the example term “below” may encompass both (e.g., opposite) orientations of above and below. The device may be otherwise oriented (rotated 90 degrees or at other orientations), and the spatially relative terms utilized herein may be interpreted accordingly.

As used herein, the terms “use,” “using,” and “used” may be considered synonymous with the terms “utilize,” “utilizing,” and “utilized,” respectively.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

The term “combination(s) thereof” may include a mixture, a laminate, a complex, a copolymer, an alloy, a blend, a reactant of constituents, and/or the like.

Unless otherwise defined, all terms (including chemical, technical and scientific terms) utilized herein have the same meaning as commonly understood by one of ordinary skill in the art to which the present disclosure belongs. In some embodiments, it will be further understood that terms, such as those defined in commonly utilized dictionaries, should be interpreted as having a meaning that is consistent with their meaning in the context of the relevant art and the present disclosure, and will not be interpreted in an idealized or overly formal sense unless expressly so defined herein.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

### Definitions

As utilized herein, the term “particle diameter” of particles refers to an average diameter if (e.g., when) particles are spherical and refers to an average major axis length if (e.g., when) particles are non-spherical. A particle diameter of particles may be measured utilizing a particle size analyzer (PSA). A “particle diameter” of particles is, for example, an “average particle diameter.” An average particle diameter refers to, for example, a median particle diameter (D50). The median particle diameter (D50) is a particle size corresponding to a 50% cumulative volume if (e.g., when) a particle size distribution measured through a laser diffraction method is calculated from particles having a smaller particle size. In some embodiments, a “particle diameter” or an “average particle diameter” may be measured from a transmission electron microscope (TEM) image, a scanning electron microscope (SEM) image, and/or the like.

D50 refers to a particle size corresponding to a 50% cumulative volume if (e.g., when) a particle size distribution measured through a laser diffraction method is calculated from particles having a smaller particle size.

D90 refers to a particle size corresponding to a 90% cumulative volume if (e.g., when) a particle size distribution measured through a laser diffraction method is calculated from particles having a smaller particle size.

D10 refers to a particle size corresponding to a 10% cumulative volume if (e.g., when) a particle size distribution measured through a laser diffraction method is calculated from particles having a smaller particle size.

In some embodiments, the term “group” may refer to a group (i.e., column) of elements in the periodic table of the elements according to the International Union of Pure and Applied Chemistry (“IUPAC”) Groups 1-18 group classification system. In some embodiments, the term “group” may refer to a chemical functional group, e.g., an “alkyl group.”

The term “metal” as utilized herein includes all of metals and metalloids such as silicon and germanium in an elemental or ionic state.

The term “electrode active material” as utilized herein refers to an electrode material that may undergo lithiation and delithiation.

The term “negative electrode active material” as utilized herein refers to a negative electrode material that may undergo lithiation and delithiation.

The terms “lithiate” and “lithiating” as utilized herein refer to a process of adding lithium to an electrode active material.

The terms “delithiate” and “delithiating” as utilized herein refer to a process of removing lithium from an electrode active material.

The terms “charge” and “charging” as utilized herein refer to a process of providing electrochemical energy to a battery.

The terms “discharge” and “discharging” as utilized herein refer to a process of removing electrochemical energy from a battery.

The term “positive electrode” as utilized herein refers to an electrode at which electrochemical reduction and lithiation occur during a discharging process.

The term “negative electrode” as utilized herein refers to an electrode at which electrochemical oxidation and delithiation occur during a discharging process.

As utilized herein, if (e.g., when) a definition is not otherwise provided, “substituted” refers to replacement of hydrogen of a compound by a substituent selected from among a deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or combinations thereof.

Hereinafter, a negative electrode active material and a rechargeable lithium battery including the same according to one or more embodiments will be described in more detail.

Some example embodiments provide a rechargeable lithium battery including a positive electrode, a negative electrode, and an electrolyte, wherein the electrolyte includes a non-aqueous organic solvent, a lithium salt, a first additive, and a second additive. In some embodiments, the negative electrode includes a negative electrode active material including a Si—C composite mixed with a separate carbon-based compound.

The rechargeable lithium battery of some example embodiments exhibits high energy density by applying the negative electrode active material including a Si—C composite mixed with a separate carbon-based compound. In some embodiments, by applying an electrolyte including two types (kinds) of additives, the rechargeable lithium battery prevents (or protects from) an increase in resistance that may be suppressed or reduced at room temperature and/or high temperature while also secures cycle-life characteristics.

A description of the electrolyte including the two types (kinds) of additives is disclosed in more detail herein.

The first additive may be or include a compound represented by Chemical Formula 1 that may stabilize the lithium salt to suppress or reduce side reactions of the electrolyte. The second additive may be or include a compound represented by Chemical Formula 2 that may be absorbed on the surface of the positive electrode. For example, absorption may occur but (e.g., through) coordination of a lone pair of electrons (e.g., on nitrogen atoms in the second additive structure) with a transition metal to stabilize the positive electrode. The absorption (e.g., coordination) may suppress or reduce side reactions (e.g., that result in precipitation of the transition metal) to improve cycle-life and high temperature characteristics of the rechargeable battery.

In some embodiments, the two types (kinds) of additives are mutually complementary to each other (e.g., electron donor and electron acceptor) and may have synergistic advantage if (e.g., when) utilized together. For example, compared with if (e.g., when) either one of the two types (kinds) of additives is utilized alone, if (e.g., when) the two types (kinds) of additives are utilized together, a rechargeable lithium battery may experience a suppressed or reduced increase in resistance at room temperature and/or a high temperature and may secure suitable or achieve improved cycle-life characteristics.

For example, the first additive may include a compound represented by Chemical Formula 1:

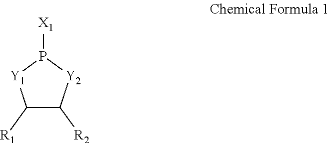

In the description of Chemical Formula 1:
X₁ may be a halogen atom, for example, a fluorine atom.
Y₁ and Y₂ may each independently be O or S, for example, both (e.g., simultaneously) may be O.

In some embodiments, Chemical Formula 1 may be represented by Chemical Formula 1-1:

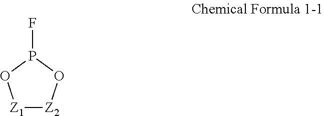

In Chemical Formula 1-1, Z¹ and Z² may each independently be a substituted or unsubstituted C1 to C5 alkylene group. For example, Z¹ may be *—CH₂—*, and Z² may be *—CHCH₃—*

A representative example of the first additive may be a compound represented by Chemical Formula 1-1-1:

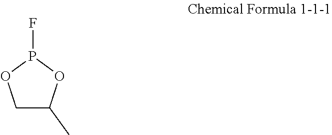

A content (e.g., amount) of the first additive in 100 wt % of the electrolyte may be greater than or equal to about 0.05 wt %, greater than or equal to about 0.1 wt %, or greater than or equal to about 0.5 wt %; and may be less than or equal to about 3 wt % or less than or equal to about 2 wt %. Within this range, an effect of improving high temperature characteristics by the first additive may occur (e.g., be significantly exhibited).

In some embodiments, the second additive includes a compound represented by Chemical Formula 2, a derivative thereof, or an adduct thereof.

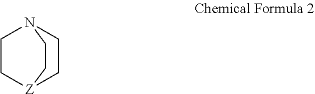

In Chemical Formula 2, Z is N or CH.

In Chemical Formula 2, if (e.g., when) Z is N, the second additive may be a compound represented by Chemical Formula 2-1-1. Additionally, if (e.g., when) Z in Chemical Formula 2 is CH, the second additive may be a compound represented by Chemical Formula 2-1-2.

The adduct of Chemical Formula 2 may include an adduct of trimethyl aluminum, sulfur dioxide, borate, or hydrosilane and the compound represented by Chemical Formula 2 (e.g., an adduct obtained by adding trimethyl aluminum, sulfur dioxide, borate, or hydrosilane to the compound represented by Chemical Formula 2). For example, the adduct of Chemical Formula 2 may be a compound represented by Chemical Formula 2-2 or 2-3.

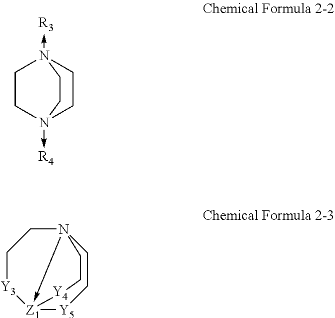

In Chemical Formulas 2-2 and 2-3, the “arrows (→)” are drawn from a side to donate (e.g., provide) electrons to a side to accept (e.g., receive) the electrons and refer to coordination bonds.

R₃ and R₄ may each independently be trimethylaluminum or sulfur dioxide. Y₃ to Y₅ may each independently be O or S, for example, all of Y₃ to Y₅ may be O. Z¹ may be B or SiH.

Representative examples of the second additive may be represented by at least one of Chemical Formula 2-1-1, Chemical Formula 2-1-2, Chemical Formula 2-2-1, Chemical Formula 2-2-2, Chemical Formula 2-3-1, or Chemical Formula 2-3-2:

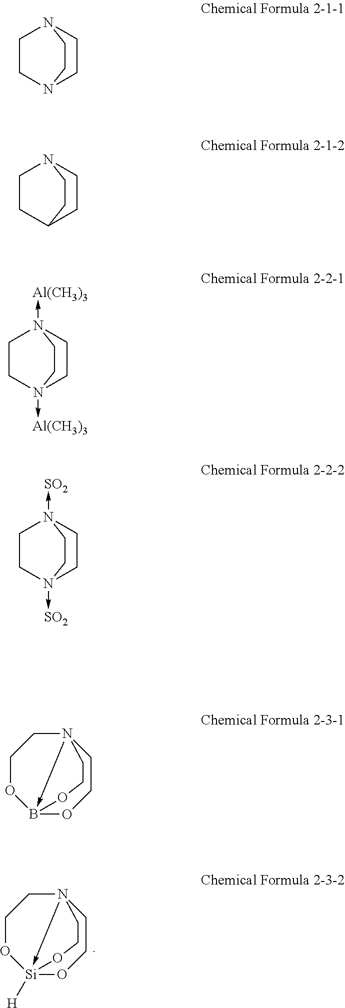

The content (e.g., amount) of the second additive in 100 wt % of the electrolyte may be greater than or equal to about 0.05 wt %, greater than or equal to about 0.1 wt %, or greater than or equal to about 0.5 wt %; and may be less than or equal to about 3 wt % or less than or equal to about 2 wt %. Within this range, an effect of improving high temperature characteristics by the second additive may occur (e.g., be significantly exhibited).

For example, a weight ratio of the first additive and the second additive may be about 1:0.1 to about 1:3. In this way, if (e.g., when) the second additive is utilized in an amount of about 0.1 to about 1.3 parts by weight based on 1 part by weight of the first additive, the synergy effect of the two types (kinds) of additives may be further increased. For example, if (e.g., when) the second additive is utilized in an amount of about 0.1 to about 1.3 parts by weight based on 1 part by weight of the first additive, more suppression or reduction of an increase in resistance at room temperature and/or a high temperature and more improved cycle-life characteristics may occur.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include at least one selected from among ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include at least one selected from among methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include at least one selected from among dibutyl ether, tetraglyme, diglyme, dimethoxyethane, 2-methyltetrahydrofuran, tetrahydrofuran, and/or the like. The ketone-based solvent may include at least one selected from among cyclohexanone and/or the like. The alcohol-based solvent may include at least one selected from among ethyl alcohol, isopropyl alcohol, and/or the like. Examples of the aprotic solvent include nitriles such as R—CN (wherein R is a C2 to C20 linear, branched, or cyclic hydrocarbon group, a double bond, an aromatic ring, or an ether bond), amides such as dimethylformamide, dioxolanes such as 1,3-dioxolane, sulfolanes, and/or the like.

The non-aqueous organic solvent may be utilized alone or in combination with one or more of them, and if (e.g., when) utilized in combination with one or more, a mixing ratio may be appropriately adjusted according to the desired or suitable battery performance, which is well understood by those skilled in the art.

The carbonate-based solvent may be prepared by mixing a cyclic carbonate and a chain carbonate. The cyclic carbonate and chain carbonate may be mixed together in a volume ratio of about 5:95 to about 50:50. If (e.g., when) the mixture is utilized as an electrolyte, it may have enhanced performance (e.g., the mixture may provide enhanced performance to the electrolyte and/or the rechargeable lithium battery).

For example, ethylene carbonate (EC) may be utilized as the cyclic carbonate, and ethylmethyl carbonate (EMC) and dimethyl carbonate (DMC) may be utilized as the chain carbonate.

For example, the non-aqueous organic solvent may include a carbonate-based solvent in which ethylene carbonate (EC), ethylmethyl carbonate (EMC), and dimethyl carbonate (DMC) are mixed. For example, the carbonate-based solvent in which ethylene carbonate (EC), ethylmethyl carbonate (EMC), and dimethyl carbonate (DMC) are mixed is mixed in a volume ratio of EC: EMC: DMC=about 1:0.5:0.5 to about 1:0.5:10, which may improve performance of the electrolyte.

The non-aqueous organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based solvent may be an aromatic hydrocarbon-based compound represented by Chemical Formula 3.

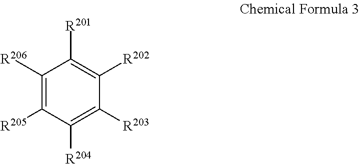

In Chemical Formula 3, R₂₀₁ to R₂₀₆ may each independently be the same or different and are selected from among hydrogen, a halogen, a C1 to C10 alkyl group, a haloalkyl group, and one or more combinations thereof.

Examples of the aromatic hydrocarbon-based solvent may be selected from among benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and one or more combinations thereof.

The electrolyte may further include vinylene carbonate, vinyl ethylene carbonate, and/or an ethylene-based carbonate-based compound of Chemical Formula 4, to improve cycle-life of a battery as a cycle-life improving additive.

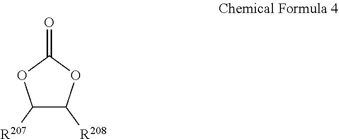

In Chemical Formula 4, R²⁰⁷ and R²⁰⁸ may each independently be the same or different and are selected from among hydrogen, a halogen, a cyano group (CN), a nitro group (NO₂), or a C1 to C5 fluoroalkyl group, provided that at least one of R²⁰⁷ and R²⁰⁸ is a halogen, a cyano group (CN), a nitro group (NO₂), or a C1 to C5 fluoroalkyl group, and R²⁰⁷ and R²⁰⁸ are not concurrently (e.g., simultaneously) hydrogen.

Examples of the ethylene carbonate-based compound include difluoro ethylene carbonate, chloroethylene carbonate, dichloroethylene carbonate, bromoethylene carbonate, dibromoethylene carbonate, nitroethylene carbonate, cyanoethylene carbonate and/or fluoroethylene carbonate. The amount of the additive for improving cycle-life may be utilized within an appropriate or suitable range.

The lithium salt dissolved in the non-aqueous organic solvent supplies lithium ions in a battery, enables a basic operation of a rechargeable lithium battery, and improves transportation of the lithium ions between positive and negative electrodes. Examples of the lithium salt include at least one selected from among LiPF₆, LiBF₄, LiDFOP, LiDFOB, LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiN(CₓF₂ₓ₊₁SO₂) (C_{y}F_{2y+1}SO₂), wherein, x and y are natural numbers, for example an integer of 1 to 20, LiCl, Lil, and/or LiB(C₂O₄)₂ (lithium bis(oxalato) borate: LiBOB). The lithium salt may be utilized in a concentration in a range of about 0.1 M to about 2.0 M. If (e.g., when) the lithium salt is included at the above concentration range, an electrolyte may have excellent or suitable performance and lithium ion mobility due to optimal or suitable electrolyte conductivity and viscosity.

The negative electrode includes a negative electrode current collector and a negative electrode active material layer including a negative electrode active material formed on the negative electrode current collector.

The negative electrode active material includes a first negative electrode active material and a second negative electrode active material. In some embodiments, the first negative electrode active material includes a Si—C composite and a first carbon-based negative electrode active material. In some embodiments, the Si—C composite includes a Si-based active material (e.g., silicon particles). In some embodiments, the second negative electrode active material includes a second carbon-based negative electrode active material.

The first negative electrode active material and the second negative electrode active material may be included in the form of a mixture, in which case the first negative electrode active material and the second negative electrode active material may be included in a weight ratio of about 1:99 to about 99:1, or about 1:99 to about 80:20, or about 1:99 to about 60:40.

An average particle diameter of the Si-based active material (e.g., constituting the first negative electrode active material) may be about 50 nm to about 200 nm. If (e.g., when) the average particle diameter of the Si-based active material is within the described range, volume expansion that occurs during charging and discharging can be suppressed or reduced, and disconnection of the conductive path due to particle crushing during charging and discharging can be prevented or reduced.

The first carbon-based negative electrode active material (e.g., comprising (e.g., constituting) the first negative electrode active material) may be a carbon material that reversibly intercalates/deintercalates the lithium ions and may be one that is commonly or suitably utilized in a rechargeable lithium battery. Representative examples of the first carbon-based negative electrode active material may include crystalline carbon, amorphous carbon, or a combination thereof. Examples of the crystalline carbon may include graphite such as irregular, plate-shaped, flake, spherical or fibrous natural graphite or artificial graphite, and examples of the amorphous carbon may include soft carbon or hard carbon, a mesophase pitch carbonized product, calcined coke, and/or the like. For example, the first carbon-based negative electrode active material (e.g., comprising (e.g., constituting) the first negative electrode active material) may be crystalline carbon.

A weight ratio of the Si-based active material to the first carbon-based negative electrode active material (e.g., comprising (e.g., constituting) the first negative electrode active material) may be about 1:99 to about 60:40, specifically about 1:99 to about 50:50, and more specifically about 1:99 to about 30:70.

The first negative electrode active material may further include a shell around (e.g., surrounding) the surface of the Si—C composite, and the shell may include amorphous carbon. The amorphous carbon may include soft carbon, hard carbon, a mesophase pitch carbonized product, calcined coke, or a mixture thereof. The amorphous carbon may be included in an amount of about 1 to about 50 parts by weight, for example, about 5 to about 50 parts by weight, or about 10 to about 50 parts by weight, based on 100 parts by weight of the carbon-based active material.

The second carbon-based negative electrode active material may include crystalline carbon. The crystalline carbon may include, for example, graphite, and for example, may include natural graphite, artificial graphite, or a mixture thereof. The crystalline carbon may have an average particle diameter of about 5 to about 30 μm. As utilized herein, the average particle diameter may be a particle size (D50) at a volume ratio of 50% in a cumulative size-distribution curve.

A total content (e.g., amount) of the first negative electrode active material and the second negative electrode active material in the negative electrode active material layer may be about 95 to about 99 wt % based on a total weight of the negative electrode active material layer.

In some example embodiments, the negative electrode active material layer may include a binder, and optionally a conductive material. In the negative electrode active material layer, the amount of the binder may be about 1 to about 5 wt % based on a total weight of the negative electrode active material layer. If (e.g., when) it further includes the conductive material, it may include about 90 to about 98 wt % of the negative electrode active material, about 1 to about 5 wt % of the binder, and about 1 to about 5 wt % of the conductive material.

The binder improves binding properties of negative electrode active material particles with one another and with a current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or one or more combinations thereof.

The water-soluble binder may be a rubber-based binder or a polymer resin binder. The rubber-based binder may be selected from among a styrene-butadiene rubber, an acrylated styrene-butadiene rubber (SBR), an acrylonitrile-butadiene rubber, an acrylic rubber, a butyl rubber, a fluorine rubber, and one or more combinations thereof. The polymer resin binder may be selected from among polytetrafluoroethylene, ethylene propylene copolymer, polyethyleneoxide, polyvinylpyrrolidone, polyepichlorohydrin, polyphosphazene, polyacrylonitrile, polystyrene, an ethylene propylenediene copolymer, polyvinylpyridine, chlorosulfonatedpolyethylene, latex, a polyester resin, an acrylic resin, a phenolic resin, an epoxy resin, polyvinylalcohol, and one or more combinations thereof.

If (e.g., when) the water-soluble binder is utilized as the negative electrode binder, a cellulose-based compound may be further utilized to provide viscosity as a thickener. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of about 0.1 parts by weight to 3 parts by weight based on 100 parts by weight of the negative electrode active material.

The conductive material is included to provide electrode conductivity and any electrically conductive material may be utilized as a conductive material unless it causes a chemical change. Examples thereof may be a carbon-based material such as natural graphite, artificial graphite, carbon black, acetylene black, Ketjen black, carbon fiber and/or the like; a metal-based material such as a metal powder or a metal fiber of copper, nickel, aluminum, silver, and/or the like; a conductive polymer such as a polyphenylene derivative and/or the like, or one or more mixtures (or combinations) thereof.

The negative electrode current collector may be selected from among a copper foil, a nickel foil, a stainless steel foil, a titanium foil, a nickel foam, a copper foam, a polymer substrate coated with a conductive metal, and one or more combinations thereof.

The positive electrode includes a positive electrode current collector and a positive electrode active material layer on the positive electrode current collector, and the positive electrode active material layer includes a positive electrode active material.

For example, the positive electrode active material may include a lithium nickel-based composite oxide represented by Chemical Formula A1:

Liₐ₁Niₓ₁M¹_{y1}M²_{z1}O_{2-b1}X_{b1} Chemical Formula A1

In Chemical Formula A1, 0.9≤a1≤1.2, 0.7≤x1≤1, 0≤y1≤0.2, 0≤z1≤0.2, 0.9≤x1+y1+z1≤1.1, and 0≤b1≤0.1; M¹ and M² may each independently be one or more element selected from among A1, B, Ba, Ca, Ce, Co, Cr, Cu, Fe, Mg, Mn, Mo, Nb, Si, Sr, Ti, V, W, and Zr; and X is one or more element selected from among F, P, and S.

In Chemical Formula A1, 0.75≤x1≤1, 0≤y1≤0.18, and 0≤z1≤0.18; 0.85≤x1≤1, 0≤y1≤0.15, and 0≤z1≤0.15; or 0.9≤x1≤1, 0≤y1≤0.1, and 0≤z1≤0.1.

For example, the positive electrode active material may include a lithium nickel-based composite oxide represented by Chemical Formula A2. The compound represented by Chemical Formula A2 may be referred to be a lithium nickel cobalt-based complex oxide:

Liₐ₂Niₓ₂CO_{y2}M³_{z2}O_{2-b2}X_{b2} Chemical Formula A2

In Chemical Formula A2, 0.9≤a2≤1.8, 0.7≤x2<1, 0<y2≤0.2, 0≤z2≤0.2, 0.9≤x2+y2+z2≤1.1, and 0≤b2≤0.1, M³ is one or more element selected from among A1, B, Ba, Ca, Ce, Cr, Fe, Mg, Mn, Mo, Nb, Si, Sr, Ti, V, W, and Zr, and X is one or more element selected from among F, P, and S.

In Chemical Formula A2, 0.75≤x2≤0.99, 0≤y2≤0.15, and 0≤z2≤0.15; 0.85≤x2≤0.99, 0.01≤y2≤0.15, and 0.01≤z2≤0.15; or 0.9≤x2≤0.99, 0.01≤y2≤0.1, and 0.01≤z2≤0.1.

As an example, the positive electrode active material may include a lithium nickel-based composite oxide represented by Chemical Formula A3. The compound of Chemical Formula A3 may be referred to as lithium nickel-cobalt-aluminum oxide or lithium nickel-cobalt-manganese oxide.

Liₐ₃Niₓ₃CO_{y3}M⁴_{z3}M⁵_{w3}O_{2-b3}X_{b3} Chemical Formula A3

In Chemical Formula A3, 0.9≤a3≤1.8, 0.7≤x3≤0.98, 0.01≤y3≤0.19, 0.01≤z3≤0.19, 0≤w3≤0.19, 0.9≤x3+y3+z3+w3≤1.1, and 0≤b3≤0.1, M⁴ is one or more element selected from among A1 and Mn, M⁵ is one or more element selected from among B, Ba, Ca, Ce, Cr, Fe, Mg, Mo, Nb, Si, Sr, Ti, V, W, and Zr, and X is one or more element selected from among F, P, and S.

In Chemical Formula A3, 0.75≤x3≤0.98, 0≤y3≤0.16, and 0≤z3≤0.16; 0.85≤x3≤0.98, 0.01≤y3≤0.14, 0.01≤z3≤0.14, and 0≤w3≤0.14; or 0.9≤x3≤0.98, 0.01≤y3≤0.09, 0.01≤z3≤0.09, and 0≤w3≤0.09.

As an example, the positive electrode active material may include a lithium nickel-based composite oxide represented by Chemical Formula A4. The compound of Chemical Formula A4 may be referred to be a cobalt-free lithium nickel-manganese oxide.

Liₐ₄Niₓ₄Mn_{y4}M⁶_{z4}O_{2-b4}X_{b4} Chemical Formula A4

In Chemical Formula A4, 0.9≤a2≤1.8, 0.7≤x4<1, 0<y4≤0.2, 0≤z4≤0.2, 0.9≤x4+y4+z4≤1.1, and 0≤b4≤0.1, M⁶ is one or more element selected from among A1, B, Ba, Ca, Ce, Cr, Fe, Mg, Mo, Nb, Si, Sr, Ti, V, W, and Zr, and X is one or more element selected from among F, P, and S.

A content (e.g., amount) of the positive electrode active material may be about 90 wt % to about 98 wt % based on a total weight of the positive electrode active material layer.

In some embodiments of the present disclosure, the positive electrode active material layer may optionally include a conductive material and a binder. In this case, each content (e.g., amount) of the conductive material and the binder may be about 1.0 wt % to about 5.0 wt %, based on a total weight of the positive electrode active material layer.

The conductive material is utilized to impart conductivity to the negative electrode, and any electrically conductive material may be utilized as a conductive material unless it causes a chemical change in a battery. Examples of the conductive material may include a carbon-based material such as natural graphite, artificial graphite, carbon black, acetylene black, Ketjen black, carbon fiber, and/or the like; a metal-based material of a metal powder or a metal fiber including copper, nickel, aluminum, silver, and/or the like; a conductive polymer such as a polyphenylene derivative; or a mixture thereof.

The binder improves binding properties of positive electrode active material particles with one another and with a current collector and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

The positive electrode current collector may include A1, but is not limited thereto.

The rechargeable lithium battery may further include a separator between the negative electrode and the positive electrode, depending on a type or kind of the rechargeable lithium battery. This separator may be a porous substrate; or may be a composite porous substrate.

The porous substrate may be a substrate including pores, and lithium ions may move through the pores. The porous substrate may be for example may include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The composite porous substrate may have a form including a porous substrate and a functional layer on the porous substrate. The functional layer may be, for example, at least one of a heat-resistant layer and an adhesive layer from the viewpoint of enabling additional function. For example, the heat-resistant layer may include a heat-resistant resin and optionally a filler.

In some embodiments, the adhesive layer may include an adhesive resin and optionally a filler.

The filler may be an organic filler and/or an inorganic filler.

Herein, as an example of a rechargeable lithium battery, a cylindrical rechargeable lithium battery is for example described. The drawing schematically shows the structure of a rechargeable lithium battery according to some example embodiments. Referring to the drawing, a rechargeable lithium battery 100 according to some example embodiments includes a battery cell including a positive electrode 114, a negative electrode 112 facing the positive electrode 114, a separator 113 between the positive electrode 114 and the negative electrode 112, and an electrolyte impregnating the positive electrode 114, the negative electrode 112, and the separator 113, a battery case 120 housing the battery cell, and a sealing member 140 sealing the battery case 120.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, examples and comparative examples of the present disclosure will be described. The following example is only an example of the present disclosure, and the present disclosure is not limited to the following examples.

### EXAMPLES

### Preparation of Electrolyte for Rechargeable Lithium Battery Cells Preparation Example 1

As for a non-aqueous organic solvent, a carbonate-based solvent was prepared by mixing ethylene carbonate (EC): ethylmethyl carbonate (EMC): dimethyl carbonate (DMC)=20:10:70 in a volume ratio.

To the non-aqueous organic solvent, 1.5 M lithium salt (LiPF₆) was added, and 1 wt % of the first additive represented by Chemical Formula 1-1-1 (CAS No. 16415 Sep. 1) and 0.1 wt % of the second additive represented by Chemical Formula 2-1-1 (CAS No. 280-57-9) were added thereto to finally prepare an electrolyte for a rechargeable lithium battery.

Herein, a content (e.g., amount) (wt %) of each of the additives refers to the content (e.g., amount) (wt %) of each of the additives based on 100 wt % of the electrolyte for a rechargeable lithium battery. The same was applied hereinafter.

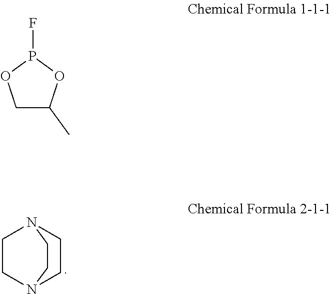

### Preparation Example 2

An electrolyte for a rechargeable lithium battery was manufactured in substantially the same manner as in Preparation Example 1 except that 1 wt % of the first additive represented by Chemical Formula 1-1-1 (CAS No. 16415 Sep. 1) and 0.5 wt % of the second additive represented by Chemical Formula 2-1-1 (CAS No. 280-57-9) were utilized as the additives.

### Preparation Example 3

An electrolyte for a rechargeable lithium battery was manufactured in substantially the same manner as in Preparation Example 1 except that 1 wt % of the first additive represented by Chemical Formula 1-1-1 (CAS No. 16415 Sep. 1) and 1.0 wt % of the second additive represented by Chemical Formula 2-1-1 (CAS No. 280-57-9) were utilized as the additives.

### Preparation Example 4

An electrolyte for a rechargeable lithium battery was manufactured in substantially the same manner as in Preparation Example 1 except that 1 wt % of the first additive represented by Chemical Formula 1-1-1 (CAS No. 16415 Sep. 1) and 3.0 wt % of the second additive represented by Chemical Formula 2-1-1 (CAS No. 280-57-9) were utilized as the additives.

### Comparative Preparation Example 1

An electrolyte for a rechargeable lithium battery was manufactured in substantially the same manner as in Preparation Example 1 except that the additives were not utilized at all.

### Comparative Preparation Example 2

An electrolyte for a rechargeable lithium battery was manufactured in substantially the same manner as in Preparation Example 1 except that the first additive represented by Chemical Formula 1-1-1 (CAS No. 16415 Sep. 1) was not utilized, but 0.1 wt % of the second additive represented by Chemical Formula 2-1-1 (CAS No. 280-57-9) were utilized as the additive.

### Comparative Preparation Example 3

An electrolyte for a rechargeable lithium battery was manufactured in substantially the same manner as in Preparation Example 1 except that 1 wt % of the first additive represented by Chemical Formula 1-1-1 (CAS No. 16415 Sep. 1) was utilized as the additive, but the second additive represented by Chemical Formula 2-1-1 (CAS No. 280-57-9) was not utilized.

### Manufacture of Rechargeable Lithium Battery Cells

### Example 1

LiNi_{0.8}CO_{0.1}Al_{0.1}O₂ as a positive electrode active material, polyvinylidene fluoride as a binder, and Ketjen black as a conductive material were mixed respectively in a weight ratio of 97:2:1, and then, dispersed in N-methyl pyrrolidone to prepare positive electrode active material slurry.

The positive electrode active material slurry was coated on a 14 micrometer (μm)-thick A1 foil, dried at 110° C., and pressed to manufacture a positive electrode.

A mixture of the first negative electrode active material and second negative electrode active material in a weight ratio of 1:99 was utilized as the negative electrode active material, and the negative electrode active material, a styrene-butadiene rubber binder, and carboxylmethyl cellulose in a weight ratio of 97:1:2 were dispersed in distilled water to prepare negative electrode active material slurry.

The first negative electrode active material included a core (Si—C composite) containing artificial graphite and silicon particles, and coal pitch coated on the surface of the core.

The negative electrode active material slurry was coated on a 10 μm-thick Cu foil, dried at 100° C., and pressed to manufacture a negative electrode.

An electrode assembly was manufactured by assembling the manufactured positive electrode and negative electrode and a 25 μm-thick polyethylene separator, and each rechargeable lithium battery cell was manufactured by injecting the electrolyte for a rechargeable lithium battery of Preparation Example 1.

### Example 2

A rechargeable lithium battery cell was manufactured in substantially the same manner as in Example 1 except that a mixture of the first negative electrode active material: the second negative electrode active material in a weight ratio of 20:80 was utilized as the negative electrode active material.

### Example 3

A rechargeable lithium battery cell was manufactured in substantially the same manner as in Example 1 except that a mixture of the first negative electrode active material: the second negative electrode active material in a weight ratio of 40:60 was utilized as the negative electrode active material.

### Example 4

A rechargeable lithium battery cell was manufactured in substantially the same manner as in Example 1 except that a mixture of the first negative electrode active material: the second negative electrode active material in a weight ratio of 60:50 was utilized as the negative electrode active material.

### Example 5

A rechargeable lithium battery cell was manufactured in substantially the same manner as in Example 1 except that the electrolyte for a rechargeable lithium battery according to Preparation Example 2 was utilized.

### Example 6

A rechargeable lithium battery cell was manufactured in substantially the same manner as in Example 2 except that the electrolyte for a rechargeable lithium battery according to Preparation Example 2 was utilized.

### Example 7

A rechargeable lithium battery cell was manufactured in substantially the same manner as in Example 3 except that the electrolyte for a rechargeable lithium battery according to Preparation Example 2 was utilized.

### Example 8

A rechargeable lithium battery cell was manufactured in substantially the same manner as in Example 4 except that the electrolyte for a rechargeable lithium battery according to Preparation Example 2 was utilized.

### Example 9

A rechargeable lithium battery cell was manufactured in substantially the same manner as in Example 1 except that the electrolyte for a rechargeable lithium battery according to Preparation Example 3 was utilized.

### Example 10

A rechargeable lithium battery cell was manufactured in substantially the same manner as in Example 2 except that the electrolyte for a rechargeable lithium battery according to Preparation Example 3 was utilized.

### Example 11

A rechargeable lithium battery cell was manufactured in substantially the same manner as in Example 3 except that the electrolyte for a rechargeable lithium battery according to Preparation Example 3 was utilized.

### Example 12

A rechargeable lithium battery cell was manufactured in substantially the same manner as in Example 4 except that the electrolyte for a rechargeable lithium battery according to Preparation Example 3 was utilized.

### Example 13

A rechargeable lithium battery cell was manufactured in substantially the same manner as in Example 1 except that the electrolyte for a rechargeable lithium battery according to Preparation Example 4 was utilized.

### Example 14

A rechargeable lithium battery cell was manufactured in substantially the same manner as in Example 2 except that the electrolyte for a rechargeable lithium battery according to Preparation Example 4 was utilized.

### Example 15

A rechargeable lithium battery cell was manufactured in substantially the same manner as in Example 3 except that the electrolyte for a rechargeable lithium battery according to Preparation Example 4 was utilized.

### Example 16

A rechargeable lithium battery cell was manufactured in substantially the same manner as in Example 4 except that the electrolyte for a rechargeable lithium battery according to Preparation Example 4 was utilized.

### Comparative Example 1

A rechargeable lithium battery cell was manufactured in substantially the same manner as in Example 1 except that the electrolyte for a rechargeable lithium battery according to Comparative Preparation Example 1 was utilized.

### Comparative Example 2

A rechargeable lithium battery cell was manufactured in substantially the same manner as in Example 2 except that the electrolyte for a rechargeable lithium battery according to Comparative Preparation Example 1 was utilized.

### Comparative Example 3

A rechargeable lithium battery cell was manufactured in substantially the same manner as in Example 3 except that the electrolyte for a rechargeable lithium battery according to Comparative Preparation Example 1 was utilized.

### Comparative Example 4

A rechargeable lithium battery cell was manufactured in substantially the same manner as in Example 4 except that the electrolyte for a rechargeable lithium battery according to Comparative Preparation Example 1 was utilized.

### Comparative Example 5

A rechargeable lithium battery cell was manufactured in substantially the same manner as in Example 1 except that the electrolyte for a rechargeable lithium battery according to Comparative Preparation Example 2 was utilized.

### Comparative Example 6

A rechargeable lithium battery cell was manufactured in substantially the same manner as in Example 2 except that the electrolyte for a rechargeable lithium battery according to Comparative Preparation Example 2 was utilized.

### Comparative Example 7

A rechargeable lithium battery cell was manufactured in substantially the same manner as in Example 3 except that the electrolyte for a rechargeable lithium battery according to Comparative Preparation Example 2 was utilized.

### Comparative Example 8

A rechargeable lithium battery cell was manufactured in substantially the same manner as in Example 4 except that the electrolyte for a rechargeable lithium battery according to Comparative Preparation Example 2 was utilized.

### Comparative Example 9

A rechargeable lithium battery cell was manufactured in substantially the same manner as in Example 1 except that the electrolyte for a rechargeable lithium battery according to Comparative Preparation Example 3 was utilized.

### Comparative Example 10

A rechargeable lithium battery cell was manufactured in substantially the same manner as in Example 2 except that the electrolyte for a rechargeable lithium battery according to Comparative Preparation Example 3 was utilized.

### Comparative Example 11

A rechargeable lithium battery cell was manufactured in substantially the same manner as in Example 3 except that the electrolyte for a rechargeable lithium battery according to Comparative Preparation Example 3 was utilized.

### Comparative Example 12

A rechargeable lithium battery cell was manufactured in substantially the same manner as in Example 4 except that the electrolyte for a rechargeable lithium battery according to Comparative Preparation Example 3 was utilized.

### Evaluation Example 1: DC-Internal Resistance (DC-IR) Evaluation Before and After High-Temperature Driving

Each of the rechargeable lithium battery cells was subjected to initial formation in the following process. The cells were charged at a constant current to a voltage of 4.2 volt (V) at a current rate of 0.2 coulomb (C) and subsequently, discharged at a constant current at 0.2 C to a voltage of 2.8 V at 45° C. Subsequently, the cells were constant current-charged to a voltage of 4.2 V at a current rate of 0.5 C and constant voltage-charged to 0.05 C at 4.2 V. Then, the cells were constant current-discharged to a voltage of 2.8 V at 0.5 C.

### Formation Step

After the formation step (process), the rechargeable lithium battery cells were constant current-charged to a voltage of 4.2 V at a current rate of 1.0 C and constant voltage-charged at 4.2 V to 0.05 C at 45° C. Subsequently, the cells were discharged to a voltage of 2.8 V at a constant current of 1.0 C, and this charge and discharge cycle was 300 times repeated.

A ratio of direct current (DC) resistance at the 300th cycle of the rechargeable lithium battery cells to the initial DC resistance (a resistance increase rate according to Equation 1) was calculated, and the results are shown in Table 1.

<Equation 1>resistance increase rate (ΔDC−IR)=100*(DC−IR after 300 cycles at 45° C.)/(initial DC−IR)

Herein, DC resistance (DC-IR) was calculated from a current difference and a voltage difference, if (e.g., when) different currents were applied, and specifically, calculated from data at 18 seconds and 23 seconds obtained according to ΔR=ΔV/ΔI after constant current-discharging at 10 ampere (A) for 10 seconds, at 1 A for 10 seconds, and at 10 A for 4 seconds in the initial full charge state.

TABLE 1

| | | | | Evaluation of battery cells | | |
|---|---|---|---|---|---|---|
| | Negative | | | | High- | DC-IR |
| | electrode | Electrolyte | | | temperature | increase rate |
| | active | | Content | | cycle-life | after high- |
| | material | Content | of | | capacity | temperature |
| | First: | of first | second | | retention @ | cycle-life @ |
| | Second = | additive | additive | Initial | 45° C., | 45° C., |
| | [w:w] | [wt %] | [wt %] | DC-IR | 300 cy (%) | 300 cy (%) |
| Comparative | 1 | 0 | 0 | 13.4 | 76.3 | 210.7 |
| Example 1 | | | | | | |
| Comparative | 20 | 0 | 0 | 24.1 | 66.4 | 337.1 |
| Example 2 | | | | | | |
| Comparative | 40 | 0 | 0 | 30.8 | 60.3 | 379.3 |
| Example 3 | | | | | | |
| Comparative | 60 | 0 | 0 | 52.3 | 51.9 | 442.5 |
| Example 4 | | | | | | |
| Comparative | 1 | 0 | 0.1 | 14.7 | 68.7 | 231.8 |
| Example 5 | | | | | | |
| Comparative | 20 | 0 | 0.1 | 26.5 | 59.7 | 370.8 |
| Example 6 | | | | | | |
| Comparative | 40 | 0 | 0.1 | 33.9 | 54.2 | 417.2 |
| Example 7 | | | | | | |
| Comparative | 60 | 0 | 0.1 | 57.5 | 46.7 | 486.7 |
| Example 8 | | | | | | |
| Comparative | 1 | 1 | 0 | 14.3 | 72.5 | 225.4 |
| Example 9 | | | | | | |
| Comparative | 20 | 1 | 0 | 25.8 | 63.1 | 360.7 |
| Example 10 | | | | | | |
| Comparative | 40 | 1 | 0 | 33.0 | 57.3 | 405.8 |
| Example 11 | | | | | | |
| Comparative | 60 | 1 | 0 | 55.9 | 49.3 | 473.4 |
| Example 12 | | | | | | |
| Example 1 | 1 | 1 | 0.1 | 12.6 | 81.6 | 160.1 |
| Example 2 | 20 | 1 | 0.1 | 22.7 | 71.0 | 256.2 |
| Example 3 | 40 | 1 | 0.1 | 29.0 | 64.5 | 288.2 |
| Example 4 | 60 | 1 | 0.1 | 49.1 | 55.5 | 336.3 |
| Example 5 | 1 | 1 | 0.5 | 10.7 | 96.9 | 107.5 |
| Example 6 | 20 | 1 | 0.5 | 19.3 | 84.3 | 171.9 |
| Example 7 | 40 | 1 | 0.5 | 24.7 | 76.6 | 193.4 |
| Example 8 | 60 | 1 | 0.5 | 41.8 | 65.9 | 225.7 |
| Example 9 | 1 | 1 | 1 | 11.7 | 88.5 | 151.7 |
| Example 10 | 20 | 1 | 1 | 21.0 | 77.0 | 242.7 |
| Example 11 | 40 | 1 | 1 | 26.8 | 69.9 | 273.1 |
| Example 12 | 60 | 1 | 1 | 45.5 | 60.2 | 318.6 |
| Example 13 | 1 | 1 | 3 | 12.3 | 84.7 | 185.4 |
| Example 14 | 20 | 1 | 3 | 22.2 | 73.7 | 296.7 |
| Example 15 | 40 | 1 | 3 | 28.4 | 66.9 | 333.7 |
| Example 16 | 60 | 1 | 3 | 48.1 | 57.6 | 389.4 |

Referring to Table 1, the examples, compared with the comparative examples, exhibited relatively high energy density; and were suppressed or protected from an increase in resistance at room temperature and/or a high temperature and retained (e.g., secured) desire or suitable cycle-life characteristics.

Accordingly, the rechargeable lithium battery cells represented by the examples according to some example embodiments, to which a mixture of a Si—C composite and a carbon-based compound separately therefrom was applied as a negative electrode active material, exhibited high energy density; and in addition, to which an electrolyte including two types (kinds) of additives was applied, were suppressed or protected from an increase in resistance at room temperature and/or a high temperature and secured desire or suitable cycle-life characteristics.

A battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While this present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

### DESCRIPTION OF SYMBOLS

100: rechargeable lithium battery
112: negative electrode
113: separator
114: positive electrode
120: battery case
140: sealing member

What is claimed is:

1. A rechargeable lithium battery, comprising
a positive electrode,
a negative electrode, and
an electrolyte,
the electrolyte comprising
a non-aqueous organic solvent,
a lithium salt,
a first additive, and
a second additive,
the first additive comprising a compound represented by Chemical Formula 1,
the second additive comprising a compound represented by Chemical Formula 2, a derivative thereof, or an adduct thereof,
the negative electrode comprising
a first negative electrode active material and
a second negative electrode active material,
the first negative electrode active material comprising
a Si—C composite and
a first carbon-based negative electrode active material,
the Si—C composite comprising a Si-based active material, and
the second negative electrode active material comprising a second carbon-based negative electrode active material: 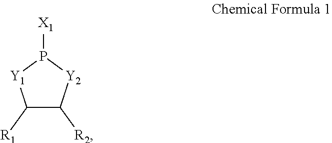
wherein, in Chemical Formula 1,
X₁ is a halogen atom;
Y₁ and Y₂ are each independently O or S; and
R₁ and R₂ are each independently H, a halogen atom, a substituted or unsubstituted C1 to C10 alkyl group, a vinyl group, a substituted or unsubstituted C6 to C10 aryl group, or a substituted or unsubstituted C2 to C10 heteroaryl group comprising a hetero atom that is N, O, or P; 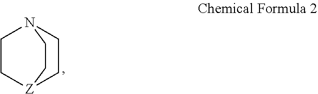
and
wherein, in Chemical Formula 2,
Z is N or CH.

2. The rechargeable lithium battery as claimed in claim 1, wherein
X₁ is a fluorine atom.

3. The rechargeable lithium battery as claimed in claim 1, wherein
Y₁ and Y₂ are simultaneously O.

4. The rechargeable lithium battery as claimed in claim 1, wherein
Chemical Formula 1 is represented by Chemical Formula 1-1: 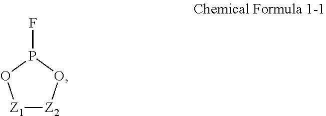
and
wherein, in Chemical Formula 1-1,
Z¹ and Z² are each independently a substituted or unsubstituted C1 to C5 alkylene group.

5. The rechargeable lithium battery as claimed in claim 4, wherein
Z¹⁰ is *—CH₂—*, and Z² is *—CHCH₃—*.

6. The rechargeable lithium battery as claimed in claim 1, wherein
the first additive is represented by Chemical Formula 1-1-1:

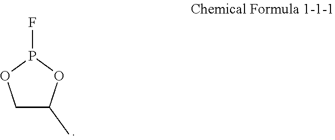

7. The rechargeable lithium battery as claimed in claim 1, wherein
an amount of the first additive in 100 wt % of the electrolyte is about 0.05 to about 3 wt %.

8. The rechargeable lithium battery as claimed in claim 1, wherein
the adduct of Chemical Formula 2 is an adduct of trimethylaluminum, sulfur dioxide, borate, or hydrosilane and the compound represented by Chemical Formula 2.

9. The rechargeable lithium battery as claimed in claim 1, wherein
the adduct of Chemical Formula 2 is a compound represented by Chemical Formula 2-2 or 2-3: 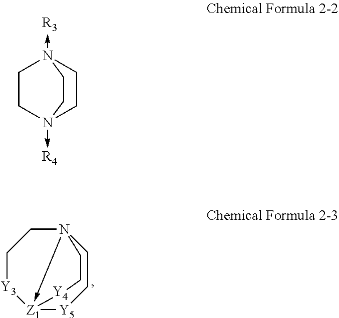
and
wherein, in Chemical Formulas 2-2 and 2-3,
R₃ and R₄ are each independently trimethylaluminum or sulfur dioxide,
Y₃ to Y₅ are each independently O or S; and
Z₁ is B or SiH.

10. The rechargeable lithium battery as claimed in claim 9, wherein
the second additive comprises at least one selected from among a compound represented by Chemical Formula 2-1-1, a compound represented by Chemical Formula 2-1-2, a compound represented by Chemical Formula 2-2-1, a compound represented by Chemical Formula 2-2-2, a compound represented by Chemical Formula 2-3-1, and a compound represented by Chemical Formula 2-3-2:

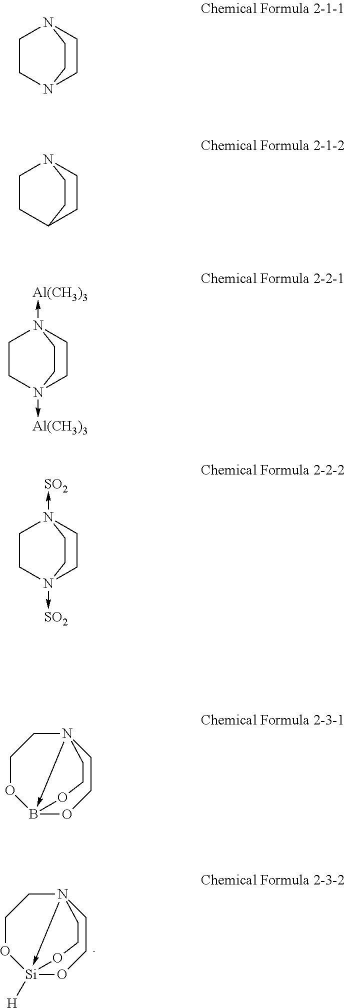

11. The rechargeable lithium battery as claimed in claim 1, wherein
an amount of the second additive in 100 wt % of the electrolyte is about 0.05 to about 3 wt %.

12. The rechargeable lithium battery as claimed in claim 1, wherein
a weight ratio of the first additive and the second additive is about 1:0.1 to about 1:3

13. The rechargeable lithium battery as claimed in claim 1, wherein
the non-aqueous organic solvent comprises a carbonate-based, ester-based, ether-based, ketone-based, alcohol-based, and/or aprotic solvent.

14. The rechargeable lithium battery as claimed in claim 13, wherein
the non-aqueous organic solvent comprises a cyclic carbonate and a chain carbonate in a volume ratio of about 5:95 to about 50:50.

15. The rechargeable lithium battery as claimed in claim 1, wherein
a weight ratio of the first negative electrode active material and the second negative electrode active material is about 1:99 to about 99:1.

16. The rechargeable lithium battery as claimed in claim 1, wherein
an average particle diameter of the Si-based active material is about 50 nanometer (nm) to about 200 nm.

17. The rechargeable lithium battery as claimed in claim 1, wherein
the first carbon-based negative electrode active material is crystalline carbon.

18. The rechargeable lithium battery as claimed in claim 1, wherein
a weight ratio of the Si-based active material and the first carbon-based negative electrode active material is about 1:99 to about 60:40.

19. The rechargeable lithium battery as claimed in claim 1, wherein
the second carbon-based negative electrode active material is crystalline carbon.

20. The rechargeable lithium battery as claimed in claim 1, wherein
an average particle diameter of the second carbon-based negative electrode active material is about 5 micrometer (μm) to about 30 μm.
